(19) United States
(12) Patent Application Publication
(10) Pub. No.: US 2011/0170095 A1
(43) Pub. Date: Jul. 14, 2011

(54) DSC-RAMEN ANALYTICAL SYSTEM AND METHOD

(75) Inventors: Kevin Peter Menard, Denton, TX (US); Enrique Lozano Diz, Seer Green (GB); Richard Spragg, High Wycombe (GB)

(73) Assignees: PerkinElmer Health Sciences, Inc., Waltham, MA (US); PerkinElmer Ltd., Seer Green (GB)

(21) Appl. No.: 12/953,550

(22) Filed: Nov. 24, 2010

Related U.S. Application Data
(60) Provisional application No. 61/264,428, filed on Nov. 25, 2009.

(51) Int. Cl. G01J 3/44

(52) U.S. Cl. 356/301

(57) ABSTRACT

A combination DSC testing and Raman spectroscopy system is provided for running investigations on a single sample in the same experiment. A DSC instrument includes a set of optics, which allows an associated Raman unit to emit a pulsed laser that intermittently directs a laser signal to the sample and to collect the Raman signal while simultaneously running a DSC experiment on the same sample. The DSC has a vessel adapted to contain the sample, a thermal analysis environment is adapted to hold the vessel. An associated temperature control apparatus changes the temperature of the analysis environment between temperature endpoints to observe the sample at various transitions. The Raman spectroscopy unit is configured to generate laser pulses which stimulate emission of Raman spectra to provide further information about the sample without introducing excessive noise in the DSC aspect of the investigation.

### CROSS-REFERENCE TO RELATED APPLICATIONS

The present application claims the benefit of U.S. Provisional Patent Application Ser. No. 61/264,428, which was filed on Nov. 25, 2009, by Kevin Peter Menard et al. for a DSC-RAMAN ANALYTICAL METHOD, which is hereby incorporated by reference.

### BACKGROUND OF THE INVENTION 1. Field of the Invention

The present invention relates to a calorimetric technique for collecting data about a sample using combined techniques.

2. Background Information

In pharmaceutical and other disciplines, there are a number of techniques used to examine and to test samples of substances that are to be sold commercially. These tests ensure uniformity across a batch of compounds and determine the presence of, or amount of, an element in the composition, and the like. Such tests are found to improve accuracy of properties of a sample to be investigated.

To that end, in such investigations, Differential Scanning calorimetry (DSC), is often used to determine the precise temperature and energy of a transition in the sample, for example from a solid phase to a liquid phase. The investigation is typically performed at temperature between two temperature endpoints as selected by the user. As the investigation proceeds, the sample undergoes transitions, e.g., melting. Transition temperatures are used as indicators of change in the properties in the sample. Measuring subtle shifts in transition temperatures and the energy of the transition is helpful in understanding material processes using a DSC investigation.

Raman spectroscopy is a technique that is used for material characterization, having found application in such areas as polymorph identification in pharmaceuticals, and crystallization of polymers including reaction monitoring of such polymers.

Both DSC and Raman interrogation methods are quite useful for performing the tests mentioned above. Conventionally, such tests are done separately. For example, the DSC investigation elucidates the occurrence of a transition, but does not generate structural information. Raman, on the other hand, provides information about the structure of the sample in a continuous manner, but does not provide information about the thermodynamic parameters of transitions. Performing each test separately has disadvantages including duplication of hardware and use of multiple samples, which can result in non-uniform results.

There remains a need, therefore, for a system that includes a DSC technique combined with Raman spectroscopy in a single arrangement which avoids the disadvantages outlined above.

### SUMMARY OF THE INVENTION

A system for investigating a sample comprises a differential scanning calorimeter, a Raman spectroscopy unit, a subsystem of optic fibers and a controller. The differential scanning calorimeter has a vessel adapted to contain the sample, a thermal analysis environment adapted to house the vessel, a temperature control apparatus configured to change the temperature of the analysis environment between temperature endpoints, and a heat measurement apparatus adapted to ascertain heat flux relative to the analysis environment. The Raman spectroscopy unit is configured to generate Raman spectra of the sample between the temperature endpoints. The Raman unit has a detector and a laser excitation source which is adapted alternately to irradiate and not to irradiate the sample. The subsystem includes one or more optic fibers coupling the Raman spectroscopy unit and the analysis environment; one or more optic fibers are configured to provide a laser signal from said laser excitation source to the sample in the analysis environment, and one or more optic fibers are configured to transmit radiation scattered from the sample in the analysis environment to the detector. The controller is configured to issue commands to the differential scanning calorimeter and Raman unit, receive data from the differential scanning calorimeter and the Raman unit, prevent operation of the heat measurement apparatus during irradiation of the sample, and generate a DSC curve expressing thermal data obtained only during times when the sample is not being irradiated.

A related method of investigating a sample comprises placing the sample in a thermal analysis environment of a differential scanning calorimeter, changing the temperature in the analysis environment between temperature endpoints, and alternatively irradiating and not irradiating the sample in the analysis environment by a laser signal. Additionally, the method includes collecting radiation scattered from the sample in the analysis environment;, generating Raman spectra between the temperature endpoints from collected scattered radiation; ascertaining heat flux relative to the analysis environment while changing the temperature in the analysis environment; and generating a DSC curve expressing thermal data ascertained only during times in which the sample is not irradiated.

In another embodiment, a system for investigating a sample comprises a power-compensated differential scanning calorimeter, a Raman spectroscopy unit, a first optic fiber, a second optic fiber, and a controller. The power-compensated differential scanning calorimeter has a vessel adapted to contain the sample, a thermal analysis environment adapted to house the vessel, a temperature control apparatus configured to change the temperature of the analysis environment in successive distinct isothermal periods between temperature endpoints, and a heat measurement apparatus adapted to ascertain heat flux relative to the analysis environment. The Raman spectroscopy unit is configured to generate a Raman spectra of the sample between the temperature endpoints received at a detector, and having a laser excitation source adapted alternately to irradiate and not to irradiate the sample. The first optic fiber is configured to couple a laser signal from said laser excitation source onto the sample in the analysis environment. The second optic fiber is configured to couple radiation scattered from the sample in the analysis environment to the detector. The controller couples the differential scanning calorimeter and the Raman unit and is configured to command the Raman unit to irradiate the sample only during a first part of each isothermal period and to generate a DSC curve from heat flux information ascertained by the differential scanning calorimeter.

In another embodiment, a method of investigating a sample comprises placing the sample in a thermal analysis environment of a power-compensated differential scanning calorimeter; changing the temperature in the analysis environment in successive distinct isothermal periods between temperature endpoints; irradiating the sample in the analysis environment by a laser signal without causing at least one of a chemical or phase change in the sample; collecting radiation scattered from the sample in the analysis environment; generating Raman spectra between the temperature endpoints from collected scattered radiation; ascertaining heat flux relative to the analysis environment while changing the temperature in the analysis environment; and generating a DSC curve from heat flux information ascertained by the differential scanning calorimeter.

In yet another embodiment, a method of investigating a sample comprises configuring a vessel having a floor coated with metal nanoparticles; placing the sample onto the nanoparticles, in the vessel; setting the temperature of the sample in the vessel to a temperature greater than the temperature of a phase transition; and cooling the material to cause it to undergo the phase transition while subjecting the sample in the vessel to differential scanning calorimetry, the phase transition initiating at the nanoparticles.

### BRIEF DESCRIPTION OF THE DRAWINGS

The invention description below refers to the accompanying drawings, of which:

FIG. 1 is a schematic cross section and block diagram of a system in accordance with an illustrative embodiment of the invention;

FIG. 2A is a side section of a dimpled pan in an illustrative embodiment of the invention;

FIG. 2B is a top plan view of the dimpled-bottomed DSC pan of FIG. 2A;

FIG. 3 is a perspective view of the DSC subsystem and a probe that includes a lens for directing Raman laser to the sample;

FIG. 4A is a more detailed side section of the probe and lens of FIG. 3 in an illustrative embodiment of the invention;

FIG. 4B is a more detailed top plan view of the lens of FIG. 4B;

FIG. 5A is a graph illustrating a DSC run using a power compensated DSC and illustrating a heat flux curve with Temperature/° C. plotted on the abscissa and heat flux on the ordinate;

FIGS. 5B through 5E each illustrate Raman spectra that are collected during the experiment reflected in FIG. 5A;

FIG. 6A is a graph illustrating a step scan procedure which shows heat and hold sequences in the DSC pulse;

FIG. 6B depicts a graph of an applied DSC pulse, and two Raman pulses, transmitted during the stabilization time of the isotherm; and

FIG. 6C the graph, as observed by the user, having Time(s) plotted on the abscissa and temperature on the ordinate.

### DETAILED DESCRIPTION OF AN ILLUSTRATIVE EMBODIMENT

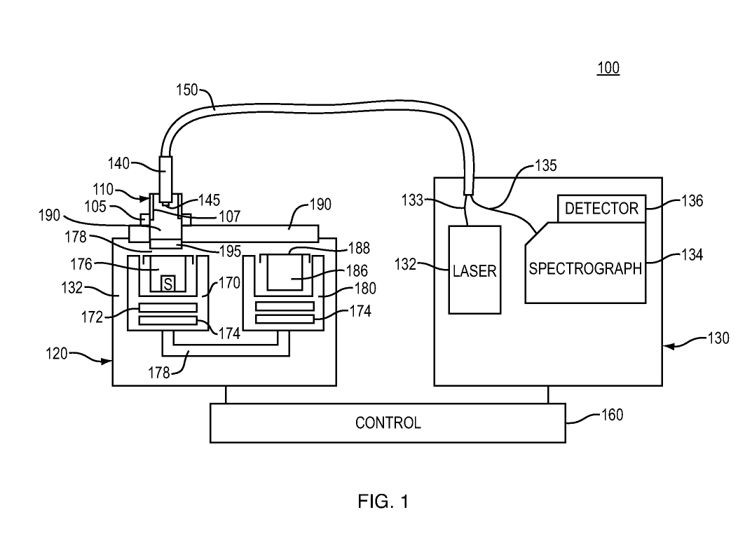

FIG. 1 illustrates a system 100 embodying the invention which includes a differential scanning calorimeter (DSC) 120 and a Raman Spectroscopy unit 130 that together operate on a sample in an analysis environment. The DSC 120 and the Ramen unit 130 together elicit a comprehensive set of information for the sample being investigated. A controller 160 is appropriately programmed to command the DSC 120 and the Raman unit 130 to cooperate in performing the distinct steps of the experiment as described below. It is noted that features shown in the drawings are not necessarily to scale.

The Raman unit 130 includes a laser excitation source 132, a spectrograph 134, and a detector 136, as known to those skilled in the art. The Raman unit 130 may be, for example, PerkinElmer®, Raman Station™ 400F or Raman Flex™. The laser excitation source 132 is operable alternately to deliver and not deliver laser light to a fiber optic subsystem, described below, by operation of a shutter (not shown) thereby effecting delivery of pulsed laser light.

The DSC 120 includes a low-mass sample furnace 170, the interior of which functions as an analysis environment for the sample. The sample furnace 170 is configured to house a vessel 176 adapted to contain the sample. A reference furnace 180 is nominally identical to the sample furnace 170 and configured to house a reference pan 186 for comparison but holds no sample during the investigation. The furnace 170 has a dedicated temperature measuring device 172 and a heater 174, and furnace 180 also has a dedicated temperature measuring device 172′ and heater 174′ these features constituting a temperature control apparatus configured to change the temperature of the respective furnace between temperature endpoints selected by a user.

In the embodiment, the reference furnace 180 is in thermal communication, by coupling 178, with the sample furnace 170. The control system 160 is configured to function as a heat measurement apparatus to ascertain heat flux relative to the analysis environment through the coupling 178. The DSC 120 illustratively measures heat flow directly by a power compensation technique, for relatively rapid thermal response, as implemented in the PerkinElmer® DSC 8000 and 8500 and PYRUS™ Diamond Differential Scanning calorimeter sold commercially by PerkinElmer Health Sciences, Inc. of Waltham, Mass. Power-compensated calorimeters may provide curves exhibiting transition temperatures accurate to within, for example, about 0.01 degrees Kelvin (K) to 1.0 K. In alternative embodiments, the DSC may be a heat flux calorimeter.

The sample pan 176 and the reference pan 186 are illustratively equipped with respective identical lids 178 and 188, which are transparent in whole or part to the laser light produced in the laser excitation source 132 and the Raman signal from the sample S. The lids 178 and 188 may be, for example, made entirely of a transparent material such as quartz, or fitted with transparent windows. For operation at subambient temperatures the windows in the lids 178 and 188 may illustratively be thermally isolated from respective vessels 176 and 186 to avoid deposition on the windows of water vapor which could impede transmission of laser light and Raman signal through the window during Raman interrogation.

The DSC 120 is covered by an enclosure lid 190. The enclosure lid 190 has a window 195. The window 195 is disposed over the sample furnace 170 and the associated sample-containing vessel 176 permitting light transmission through the enclosure lid 190.

The DSC 120 and the Raman unit 130 are coupled together by a fiber optic subsystem. In accordance with one embodiment of the invention, the fiber optic subsystem utilizes two or more fiber optic bundles, each including one or more fiber optics. A first fiber optic bundle 133 and a second fiber optic bundle 135 couple respective features of the Raman unit 130 to a probe 140. The laser excitation source 132 has output coupled to the first fiber optic bundle 133. The spectrograph 134 receives input from a second optic fiber bundle 135.

The probe 140 may be, for example, a PerkinElmer® product number L132002, which is about 0.5 inch in diameter. At a distal end, the probe 140 has an off center lens 145, illustratively having a nominal working distance on the order of less than a centimeter, and configured to direct radiation delivered by the first fiber optic bundle 133 onto the sample in the analysis environment and to relay scattered light, i.e., the Raman signal from the sample into the second fiber optic bundle 135. The probe 140 may furthermore be equipped with a camera (not shown) to allow remote viewing of the sample in the DSC 120.

A lens adaptor 110 receives and holds the probe 140 over the window 195 on the enclosure 190. A fitting 105 configured to hold the lens adaptor 110, illustratively is configured with, e.g., a screw (not shown) adjustable to loosen or tighten the grip of the fitting 105 on the lens adaptor 110 to thereby allow gross adjustment of the vertical position of the lens adaptor 110 in the fitting 105. The fitting 105 may also have an XYZ mechanism 107 allowing fine positioning of the lens adaptor 110 by movement of the lens fitting 105. In this manner laser light from the excitation source 132 may be optimally focused onto the sample in the analysis environment.

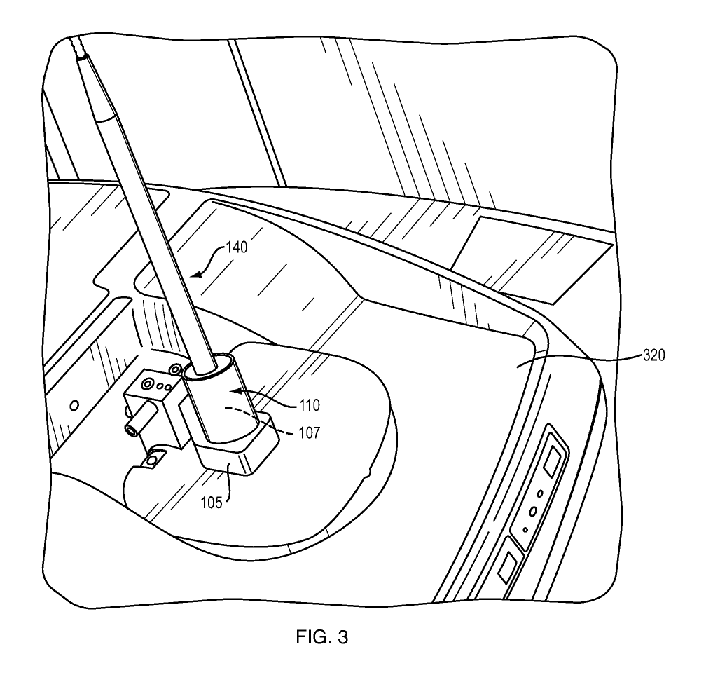

FIG. 3 is a perspective view of the external housing 320 of the DSC system 120. The housing 320 is apertured to allow light from a probe 140 into the DSC 120. As noted hereinbefore, the probe 140 seats in a lens adaptor 110 held by a fitting 105 which is movable along XYZ coordinates.

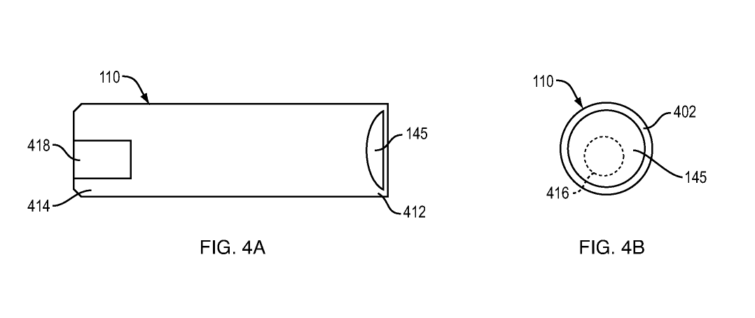

A more detailed view of the lens adaptor 110 is illustrated in FIG. 4A. More specifically, FIG. 4A illustrates an embodiment of the lens adaptor 110 in further detail. As shown in the figure, the lens adaptor 110 is a cylinder, which is illustratively constructed of anodized aluminum, hollowed to transmit light between a proximal end 412 and a distal end 414 with respect to the DSC 120 (not shown in FIG. 4A). A lens 145 is fitted onto the distal end 412 of the lens adaptor 110. The proximal end of the lens adaptor 110 includes a bore 418 for receiving the probe 140. The wall of the bore 118 is illustratively drilled and fitted with a screw (not shown) to secure the probe 140 in a fixed rotational orientation within the bore 118. Seating the probe 140 in the bore 418 fixes the distance between the distal end 414 of the probe 140 and the lens 145 at a value of, e.g., several centimeters. The axis of the bore 418 is related to the lens 145 to allow for some rotational orientation of the probe 140 As shown in FIGS. 4A and 4B, in the embodiment, the bore 418 is drilled off the center axis of the lens adaptor 110.

The configuration of the probe 140 (FIG. 3) and the lens adaptor 110 (FIGS. 4A and 4B) is illustratively such that during operation of the system 100 laser light emitted by the probe 140 irradiates the sample S in the vessel over a relatively wide spot, for example on the order of about 200 μm in diameter or greater. In conjunction with judicious selection of laser operating variables such as power and pulse parameters, proper focus of the laser light through the lens 145 onto the sample, particularly in a diffuse spot, reduces the risk of destructive localized chemical change such as by burning, phase transformation or other degradation of the sample S, laser-induced phase change in the sample, and other modes of interference with the DSC analysis by the laser energy.

Returning the FIG. 1, the controller 160 is configured to coordinate the operation of the DSC 120 and the Raman unit 130 in executing concurrent thermal and spectroscopic analysis of a sample in the analysis environment. During operation of the DSC 120 to perform thermal analysis, the controller is configured to operate the Raman unit 130 to irradiate the sample S with laser light in a pulsed manner. The controller may be configured to pause thermal data collection during sample irradiation and some subsequent interval, or mathematically to discard portions of the DSC curve based on heat flux ascertained during irradiation of the sample. Thus a final DSC curve may be generated which expresses thermal data ascertained only during times in which the sample is not being irradiated.

The controller may be furthermore configured to coordinate the timing, frequency or duration of intermittent irradiation of the sample by the laser excitation source 132 with operating parameters of the DSC 120. In one approach the DSC 120 may be operable to increase the temperature of the analysis environment by applying recurring thermal pulses that punctuate isothermal periods. As used herein, an “isothermal period” may include an initial ramping or stepping profile and thus not be strictly isothermal. The controller 160 may be operable to apply laser light to the sample consistently during a particular portion of the respective isothermal periods such as a first portion, e.g., the first tenth, quarter or half of the isothermal period, or a later portion. The control system 160 may be configured to apply the radiation in two or more pulses.

The system 100 may be configured to program successive isothermal periods in the DSC temperature scan all of equal, predetermined length and, accordingly, apply periodic laser pulses synchronous with the isothermal periods. Alternatively, the system may be configured to determine durations of respective isothermal periods in situ during the analysis and, accordingly, stimulate laser pulses based on a trigger connected with the thermal pulse initiating an isothermal period. In one embodiment, the controller 160 is operable to stimulate a thermal pulse initiating a new isothermal period when the analysis environment has met a thermal stability criterion during the immediately previous isothermal period. The system 100 may be operable to combine the described modes of coordinated operation.

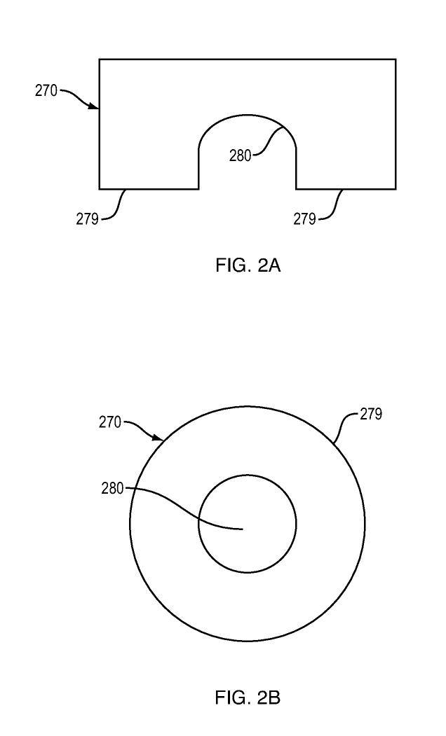

It is known that a sample may shift within the sample vessel upon melting. While not a problem for DSC analysis alone, the shifting may move the sample to a portion of the vessel that the probe 140 is not positioned to irradiate the sample, so that the Raman analysis may be adversely affected. To avoid such adverse effects, the current system may employ a sample pan that has a dimpled floor configuration. More specifically, as illustrated in FIGS. 2A and 2B, a vessel 270 has a floor with a raised dimple 280 and a circumferential ring 279, housed within wall 277. A top plan view is illustrated in FIG. 2B in which the ring 279 surrounds raised dimple 280 to form a circular recess. The sample is initially placed in this circular recess 279 and remains within the recess even after melting during the high temperature conditions. Thus the dimpled vessel 270 assists in keeping the sample in place for receiving laser light, even after sample fusion.

The interior of the vessel may be treated to bear a coating of metal nanoparticles of, e.g., silver or gold before receiving the sample S. The deposited nanoparticles may be of a substance that does not undergo thermally-induced transition over the temperature range of interest and so will not introduce artifacts into the DSC heat-temperature profile. Without being bound by any theory, we believe that the metal nanoparticles in contact with the sample serve as heterogeneous nucleation sites facilitating its crystallization during the thermal analysis, improving sample-to-sample reproducibility of crystallization phenomenon.

Nanoparticles serving as heterogeneous crystallization sites for the sample may have diameters of, e.g., 10, 50, 100 or 200 nm. In one embodiment, the metal nanoparticles are applied to the sample pan 176 by placement of a colloidal suspension in the vessel 176 and evaporating the solvent. Suitable suspensions of gold nanoparticles are available from, e.g., BBInternational, UK. The total mass of the deposited nanoparticles may be miniscule compared to the sample mass. For a standard DSC sample pan with a nominal capacity of 45 μL, the nanoparticles may be applied by depositing several microliters of a nanoparticle suspension in the pan to cover the bottom and letting dry overnight.

In another embodiment, the presence of metal nanoparticles in the sample pan 176 or 270 may also be beneficial for reproducibility in stand-alone DSC analysis without the additional vibrational spectroscopic aspect of the DSC-Raman system 100. In the

Raman-DSC system 100, the metal nanoparticles may further introduce surface-enhanced Raman scattering wherein Raman signal from samples in contact with nanoscale metal surfaces may be enhanced by a factor on the order of 10⁵ or 10⁶. The addition of constituents to a sample in order to provoke such enhancement during analysis by Raman spectroscopy is known in the art and practiced in Surface-Enhanced Raman Spectroscopy (“SERS”).

In operation, the system 100 is prepared for investigation of a sample composition such as a pharmaceutical or a polymer may be studied using the system of the present invention to determine valuable information about one or more transformations undergone by the sample material when heated or cooled (DSC) and about structure at the molecular level including crystalline and amorphous makeup (Raman), both of which are related to desired properties of the sample substance. As noted, in accordance with the invention, these thermal and structural investigations can be conducted in the same experiment using a single sample. Accordingly, the combined system provides the desired complementary information while avoiding duplications of system hardware and software components that are common to both systems. Further, the system saves time, and thus, reduces the overall costs of obtaining both thermal and structural analyses.

The intermittent exposure of the sample to the laser light minimizes the total amount of energy introduced into the analysis environment by the laser and, particularly in combination with power-compensated DSC techniques, reduces undesired changes in the sample and provides time between irradiating pulses for heat dissipation out of the analysis environment. Both of these aspects limit disruption of the thermal analysis introduced by the Raman analysis compared to a technique using continuous irradiation by the laser. The coordinated operation of the DSC 120 and Raman unit 130 in sample interrogation and data collection and treatment further promote quantitatively accurate thermal results, with the final generated DSC curve being equivalent to a DSC curve collected under otherwise identical conditions, i.e., without irradiation by the laser excitation source 132. In particular, features in the final generated DSC curve may occur at temperatures within 1 K, 0.5 K, 0.05 K, 0.01 K, or 1% of the temperatures at which occur corresponding features—for example, features signifying a transition between the same two forms—generated by calorimetry in the differential scanning calorimeter 120 without irradiation.

With reference to FIGS. 1-4, in an illustrative process sequence for combined DSC and Raman analysis, the system 100 is prepared by installing the lens adaptor 110 in the fitting 105 and adjusting the vertical position of the adaptor 110 so that the floor of the sample furnace 170 appears in sharp focus to an observer looking into the bore 418 at the distal end 414 of the adaptor 110. The grip of the fitting 105 on the adaptor 110 is tightened to immobilize the adaptor 110 within the fitting 105 over the enclosure lid 190 of the DSC 120.

The enclosure lid 190 is moved to allow access to the sample furnace 170. A sample S is placed in a sample vessel, for example, on the floor of a flat pan 176 or, as discussed for use with small samples, in the outer ring 279 of a dimpled pan 270 (FIGS. 2A and 2B). For convenience, we refer to the sample vessel hereinafter generically as pan 176. The pan 176 is illustratively covered with its laser-transmissive lid 178. Once the pan 176 containing the sample is in the sample furnace 170 of the calorimeter 120, the enclosure lid 190 is put in place. The position of the probe 140 may be adjusted, as needed, to correctly position the lens 145 with respect to the sample S in the pan 176.

The probe 140 is inserted into the bore 418 of the installed lens adaptor 110 with the lens 145 of the probe 140 aligned within the center of the bore 418. The position of the united lens adaptor 110 and probe 140 may be further adjusted while preliminarily operating the laser 132 in order to maximize the strength of the Raman signal.

The DSC heater 174 is used to change the temperature of the sample S in the analysis environment between selected temperature endpoints defining a temperature range of interest. The heat flow between the pans 176 and 178 is recorded in the system 100 as a function of temperature. The controller 160 is suitably programmed to command the temperature control apparatus in the DSC 120 to apply the desired temperature versus time, to the analysis environment to thermally interrogate the sample. The controller also stores the resultant heat flux data. Specifically, the DSC curve, the variation of the recorded heat flow with temperature, shows features that may be interpreted by an operator to discover, e.g., temperatures and enthalpies of phase transitions as is known to those skilled in the art.

During operation of the DSC 120, the Raman unit 130 is operated to generate laser light which is conveyed to the probe 140, emitted through the lens 145, transmitted through the window 195 and into the sample pan 176 to interact with the sample S. The laser excitation source 132 is operated only intermittently. In one approach, a shutter in the laser excitation source 132 is operated to irradiate the sample S only during discrete laser pulses lasting, for example, up to one second each. In one embodiment, one-second is pulses of irradiation are separated by 0.5 second off. The interval between pulses may depend on the data-collection capability of the detector 136. The time/frequency of illumination may be, for example, from 10 ms to a number of seconds, or even minutes depending on the analysis to be performed. The number of pulses per isothermal period is also adjustable. In accordance with an illustrative embodiment, two laser pulses per thermal pulse are applied. In an illustrative embodiment of the invention, the two laser pulses last a total of less than three seconds.

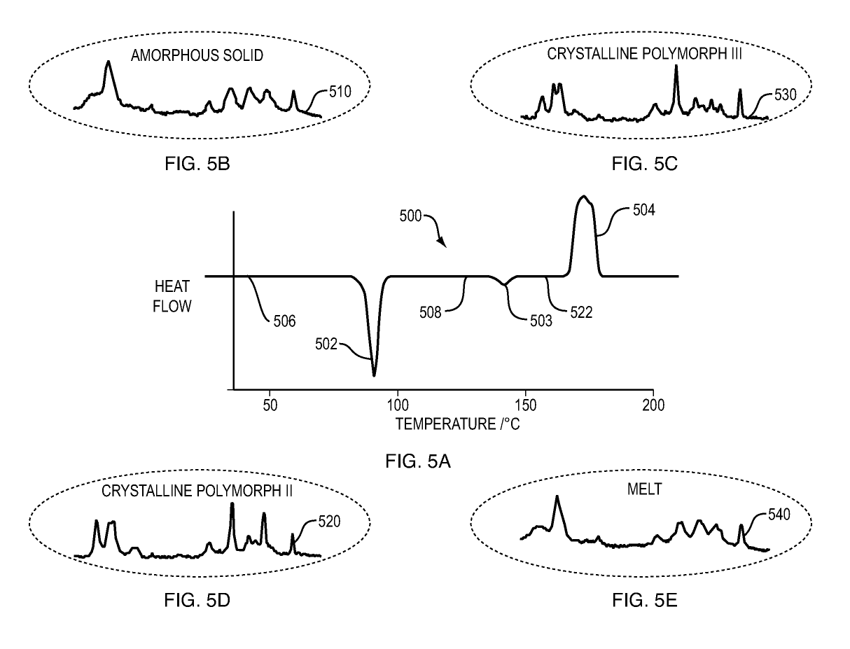

An example of concomitant DSC and Raman data obtainable by the system 100 from a single acetaminophen sample is provided in FIG. 5. In accordance with another aspect of the invention, the reaction time and accuracy of the thermal analysis of a crystallization or liquid-solid transition induced by cooling can be increased by adding a small amount of nanoparticles as a layer at the bottom of the sample pan. The nanoparticles may be gold or another metal.

The DSC run yields a heat flow curve 500. The curve 500 is plotted as Heat Flow v. Temperature, ° C. The laser excitation source 132 is operated to illuminate the sample intermittently with a wavelength of, for example, a standard value of 785 nm. For higher temperature ranges of interest, up to 800° C., an exemplary laser wavelength range of 480-532 nm may be suitable. The acetaminophen analysis is commenced at a low-temperature endpoint of approximately 50° C. The heat flow curve continues as temperature rises at a constant rate to the high-temperature endpoint selected by the user, in this case around 200° C. Transitions in the sample are reflected as a downward spike 502, a downward spike 503, and a large upward spike 504, as is known to those skilled in the art.

As discussed herein, the Raman unit 130 irradiates the sample during the DSC thermal process just described. Illustratively, during the first portion 506 of the DSC heat flow curve 500, before the transition of the spike 502, light is inelastically backscattered from the sample and this is recorded by the detector in the Raman unit as a Raman spectrum 510 characteristic of an amorphous acetaminophen solid (FIG. 5B). At the DSC curve portion 508, the Raman signature 520 (FIG. 5D) of a crystalline polymorph II is recorded. Thus, the transition producing the thermal spike 502 may be identified as being between the amorphous and crystalline polymorph II forms of the sample substance.

At the DSC curve portion 522, the Raman signature 503 is quite small but is still a Raman spectra illustrative of a crystalline polymorph III of acetaminophen as collected from the sample. Accordingly, the transition producing the thermal spike 503 situated between curve portions 508 and 522 may be identified as being between the II and III acetaminophen polymorphs. After the peak 504, a melt spectrum 540 is recorded by the Raman unit, identifying the peak 504 as a melting transition from the acetaminophen polymorph III. Energy is inelastically backscattered, at wave numbers of 1700-1100 cm⁻¹, from the sample and transmitted back to the detector in the Raman unit 130. The backscattered radiation is detected and recorded in the Raman unit, to reflect each of the four exemplary sets of Raman information about the sample as it exists in the respective portions of the temperature range scanned by the DSC instrument 120. Notably, the DSC curve is essentially noise-free because the Raman pulses are too brief to inject enough energy into the sample to interfere substantially with the DSC information, thus allowing the DSC information to be accurately recorded.

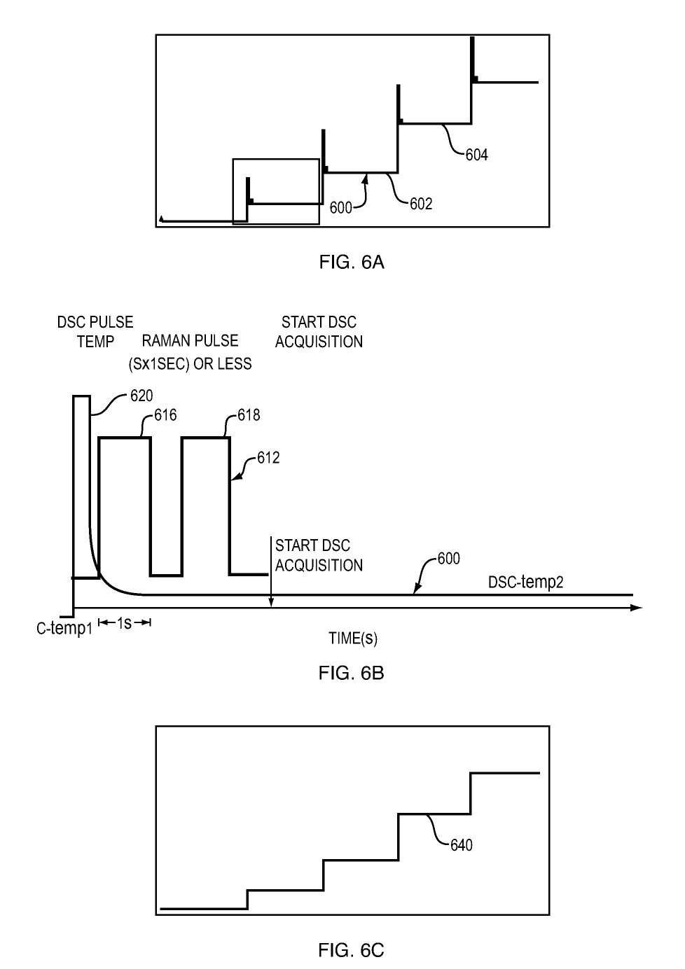

In accordance with another aspect of the invention, it may be desired to employ a DSC investigation using a heat-hold sequence over a temperature interval. A heat-hold approach is implemented by the StepScan™ DSC device sold commercially by PerkinElmer, known to those skilled in the art. Coordinating Raman pulsing with features of the thermal scan applied in the StepScan™ DSC approach may optimize accuracy of the DSC analysis in the combined DSC-Raman system. FIGS. 6A-6C illustrated a StepScan thermal methodology. More specifically, FIG. 6A shows the normal behaviour of the DSC signal using heat and hold cycles in the curve 600. For example, the system is at a constant temperature during an isotherm 602 and then temperature is increased steeply and held as shown in a subsequent isotherm 604. The duration of an isotherm 602 or 604, or equivalently, the time elapsed between two initiating thermal pulses such as the pulse 620, may be a constant predetermined duration or may be determined by the system 100 during operation. The stabilization time of the DSC signal early in an isotherm provides a window for acquiring the Raman data without significant additional destabilization of the thermal signal.

For example, an isotherm initiated by a thermal pulse 620, is illustrated in FIG. 6B with the Raman aspect of the process illustrated as the curve 612. Two irradiating laser pulses 616 and 618 are illustrated. Each pulse is illustratively of duration of one second or less, and may be up to three seconds. The top of the pulse is almost equal to the temperature of the original DSC pulse 620. After the two pulses, 616 and 618, the system 100 starts acquisition of the DSC data. FIG. 6C illustrates the final result of the thermal sequence which is observable to the user. In another embodiment, the DSC unit 120 may be operated to collect thermal data continuously and any thermal artefacts contributed by the laser irradiation are removed mathematically from the DSC curve afterward.

### EXAMPLE

A sample to be investigated was placed in a sample pan.

First, a trigger of a 5 volt (V) or other analogical signal is transmitted by the DSC system in order to start the Raman acquisition. The controller was appropriately programmed to use an I/O card for the Raman control. There was a delay in the acquisition of a Raman signal of a few milliseconds after DSC pulse to allow the DSC reach a new temperature. In this way, the system had time to stabilize thermally. The shutter in the Raman system takes less than 5 milliseconds (ms) to illuminate the sample.

During the stabilization of the DSC signal, the Raman data was acquired using at least 2 scans≦1 sec. Illustratively, a minimum of 2 scans is recommended in order to remove cosmic rays from the spectra. The minimum time to acquire data is ˜10 ms, with an illustrative amount of 0.5 sec. About 0.5-1 sec is needed to read an associated CCD camera (not shown) before the acquisition of a new Raman signal. In other words, during the reading time of the camera no laser is illuminating the sample. This provides thermal stability in the sample and it leads to less interference of the laser power into the DSC reading. This will avoid the generation of hot spots in the sample (a hot spot is the focal point of the laser illumination that can burn if a continuous illumination is used). The system uses a telescope to set the focal point of the Raman signal at 25 mm from the fibre and to irradiate a spot of ˜200 um, this reduces even more the risk of local burn. The time taken for reading the Raman CCD camera after the second Raman acquisition is used as a stabilization time, i.e., thermal relaxation of the energy introduced by the laser illumination, to avoid any interference of the laser in the DSC signal.

After 3-4 seconds as the change in temperature in the DSC, the DSC will start acquiring data. During this window between the DSC pulse and starting DSC data acquisition, the Raman laser pulses are input and the acquisition of Raman data can begin. Once the Raman data is acquired, the system is automatically setup and ready, waiting for a new 5 v trigger signal to start the next acquisition. The controller commands the temperature control apparatus to apply respective thermal pulses, initiating the isothermal periods, and to trigger irradiation of the sample by one or more laser pulses after each of the thermal pulses.

Combining the two techniques, DSC and Raman, applies complementary techniques both to observe and identify phase changes all in one experiment and using only one sample. The DSC technique provides quantitative thermal information and transition temperatures. Raman spectroscopy is interpretable at the molecular level.

The foregoing description has been directed to particular embodiments of this invention. It will be apparent, however, that other variations and modifications may be made to the described embodiments, with the attainment of some or all of their advantages. Therefore, it is the object of the appended claims to cover all such variations and modifications as come within the true spirit and scope of the invention.

What is claimed is:

1. A system for investigating a sample, comprising:
a differential scanning calorimeter having
a vessel adapted to contain the sample,
a thermal analysis environment adapted to house the vessel,
a temperature control apparatus configured to change the temperature of the analysis environment between temperature endpoints, and
a heat measurement apparatus adapted to ascertain heat flux relative to the analysis environment;
a Raman spectroscopy unit, configured to generate Raman spectra of the sample between the temperature endpoints, having a detector and a laser excitation source adapted alternately to irradiate and not to irradiate the sample;
a subsystem including one or more optic fibers coupling the Raman spectroscopy unit and the analysis environment, including one or more optic fibers configured to provide a laser signal from said laser excitation source to the sample in the analysis environment, and one or more optic fibers configured to transmit radiation scattered from the sample in the analysis environment to the detector; and
a controller configured to issue commands to the differential scanning calorimeter and Raman unit, receive data from the differential scanning calorimeter and the Raman unit, prevent operation of the heat measurement apparatus during irradiation of the sample, and generate a DSC curve expressing thermal data obtained only during times when the sample is not being irradiated.

2. The system of claim 1 wherein features of the DSC curve occur within 0.05 K of corresponding features generated by calorimetry in the differential scanning calorimeter without any irradiation of the sample by the laser excitation source.

3. The system of claim 1 further comprising a lens configured to focus laser light from an optic fiber onto the sample in the vessel.

4. The system of claim 1 wherein the differential scanning calorimeter is a power-compensated differential scanning calorimeter.

5. The system of claim 1 wherein the vessel has a lid transparent to the laser signal and the radiation scattered from the sample.

6. The system of claim 1 further comprising a camera transmitting an image of the sample in the vessel.

7. The system of claim 1 further comprising an enclosure, containing the analysis environment, having an aperture closed by a window transparent to the laser signal and the radiation scattered from the sample.

8. The system of claim 1 wherein the vessel has a floor having a periphery and a center raised compared to the periphery.

9. The system of claim 1 wherein the vessel has a floor coated with metal nanoparticles.

10. The system of claim 9 wherein the vessel is configured by depositing a suspension of the nanoparticles in a liquid onto the floor of the pan and removing the liquid from the vessel.

11. A method of investigating a sample, the method comprising:
placing the sample in a thermal analysis environment of a differential scanning calorimeter;
changing the temperature in the analysis environment between temperature endpoints;
alternatively irradiating and not irradiating the sample in the analysis environment by a laser signal;
collecting radiation scattered from the sample in the analysis environment;
generating Raman spectra between the temperature endpoints from collected scattered radiation;
ascertaining heat flux relative to the analysis environment while changing the temperature in the analysis environment; and
generating a DSC curve expressing thermal data ascertained only during times in which the sample is not irradiated.

12. The method of claim 11 wherein features of the DSC curve occur within 0.05 K of corresponding features generated by calorimetry in the differential scanning calorimeter without any irradiation of the sample by the laser signal.

13. The method of claim 11 wherein information resulting from irradiation of the sample ascertained by the heat measurement apparatus is discarded from the DSC curve.

14. The method of claim 11 wherein heat flux relative to the analysis environment is not ascertained during irradiation of the sample by the laser signal.

15. The method of claim 11 wherein the differential scanning calorimeter is a power-compensated differential scanning calorimeter.

16. The method of claim 11 wherein the vessel has a floor coated with metal nanoparticles at which a phase transition is initiated during changing the temperature of the analysis environment.

17. The method of claim 11 wherein irradiating by the laser signal cause a chemical or phase change in the sample.

18. A system for investigating a sample, comprising:
a power-compensated differential scanning calorimeter having a vessel adapted to contain the sample,
a thermal analysis environment adapted to house the vessel,
a temperature control apparatus configured to change the temperature of the analysis environment in successive distinct isothermal periods between temperature endpoints, and
a heat measurement apparatus adapted to ascertain heat flux relative to the analysis environment;
a Raman spectroscopy unit, configured to generate a Raman spectra of the sample between the temperature endpoints, a detector and having a laser excitation source adapted alternately to irradiate and not to irradiate the sample;
a first optic fiber configured to couple a laser signal from said laser excitation source onto the sample in the analysis environment;
is a second optic fiber configured to couple radiation scattered from the sample in the analysis environment to the detector; and
a controller coupling the differential scanning calorimeter and the Raman unit and configured to command the Raman unit to irradiate the sample only during a first part of each isothermal period and to generate a DSC curve from heat flux information ascertained by the differential scanning calorimeter.

19. The system of claim 18 wherein features of the DSC curve occur within 0.05 K of corresponding features generated by calorimetry in the differential scanning calorimeter without any irradiation of the sample by the laser excitation source.

20. The system of claim 18 wherein the controller is configured to command the Raman unit to irradiate the sample in two distinct laser pulses.

21. The system of claim 18 wherein the two laser pulses last a total of less than three seconds.

22. The system of claim 18 wherein the isothermal periods are of equal, predetermined duration.

23. The system of claim 18 wherein the differential scanning calorimeter is configured to initiate a new isothermal period when the analysis environment meets a thermal stability criterion during a previous isothermal period.

24. The system of claim 18 wherein the controller is configured to
command the temperature control apparatus to apply respective thermal pulses, initiating the isothermal periods, to the analysis environment, and
trigger irradiation of the sample by one or more laser pulses after each of the thermal pulses.

25. The system of claim 18 wherein the controller is configured to prevent gathering of heat flux information during irradiation of the sample by the laser and a subsequent period.

26. The system of claim 18 further comprising a lens configured to focus laser light from an optic fiber onto the sample in a spot having a diameter greater than 200 μm.

27. A method of investigating a sample, comprising:
placing the sample in a thermal analysis environment of a power-compensated differential scanning calorimeter;
changing the temperature in the analysis environment in successive distinct isothermal periods between temperature endpoints;
irradiating the sample in the analysis environment by a laser signal without causing at least one of a chemical or phase change in the sample;
collecting radiation scattered from the sample in the analysis environment;
generating Raman spectra between the temperature endpoints from collected scattered radiation;
ascertaining heat flux relative to the analysis environment while changing the temperature in the analysis environment; and
generating a DSC curve from heat flux information ascertained by the differential scanning calorimeter.

28. The method of claim 27 wherein the sample is irradiated only during a first part of each isothermal period.

29. A method of investigating a sample, the method comprising:
configuring a vessel having a floor coated with metal nanoparticles;
placing the sample onto the nanoparticles, in the vessel;
setting the temperature of the sample in the vessel to a temperature greater than the temperature of a phase transition; and
cooling the material to cause it to undergo the phase transition while subjecting the sample in the vessel to differential scanning calorimetry, the phase transition initiating at the nanoparticles.

30. The method of claim 29 further comprising collecting Raman spectra of the sample in the vessel before and after the phase transition.
